(19) United States
(12) Patent Application Publication
(10) Pub. No.: US 2004/0155218 A1
(43) Pub. Date: Aug. 12, 2004

(54) Ball valve having easily assembling structure

(76) Inventor: Shyh Chyuan Wang, Taichung Hsien (TW)

Correspondence Address: Shyh Chyuan Wang, P.O. Box 196, Fung Yung, Taichung, 420, TW

(21) Appl. No.: 10/361,428

(22) Filed: Feb. 6, 2003

(51) Int. Cl. F16K 5/06

(52) U.S. Cl. 251/315.01

(57) ABSTRACT

A ball valve includes a tubular element having an annular flange extended in the middle portion, and having a valve chamber formed in one end to receive two gaskets and a ball valve member, and having a barrel. A shank is rotatably received in the barrel and coupled to the ball valve member, to rotate the ball valve member relative to the tubular element. A duct includes a peripheral swelling extended from one end and engaged into the valve chamber of the tubular element, and secured to the tubular element with a welding member, for allowing the ball valve member and the gaskets to be easily assembled into the tubular element.

### BACKGROUND OF THE INVENTION

1. Field of the Invention

The present invention relates to a ball valve, and more particularly to a metal or stainless ball valve having a structure for allowing the ball valve to be easily manufactured and assembled.

2. Description of the Prior Art

Various kinds of typical ball valves have been developed and provided for coupling to hoses or pipes, and to control the water flowing through the hoses or pipes.

As shown in FIG. 1, illustrated is one of the typical ball valves and comprises a cylindrical or tubular body 1 including a lateral passage 101 formed therein, and including a barrel 102 extended upwardly from the middle portion thereof, and including inner threads 103 formed in the ends thereof to thread and to couple or secure to the other hoses or pipes (not shown).

An annular flange 104 is extended radially into the passage 101 of the tubular body 1, a ball valve member 2 is rotatably received in the middle portion of the tubular body 1 and engaged with the annular flange 104 of the tubular body 1, and a lock washer or nut 6 includes an outer thread 601 for threading with the inner thread 103 that is formed in the other end of the tubular body 1, for engaging with and for retaining the ball valve member 2 in the middle portion of the passage 101 of the tubular body 1.

One or more, such as two washers or Teflon gaskets 5 are further provided and engaged between the annular flange 104 of the tubular body 1 and the lock washer or nut 6 and the ball valve member 2, in order to make a water tight seal between the tubular body 1 and the ball valve member 2. The ball valve member 2 includes a bore 200 formed therein to selectively align with the lateral passage 101 of the tubular body 1, in order to control the water flowing through the tubular body 1. The ball valve member 2 further includes a recess 201 formed in the upper portion thereof.

A shank 3 is rotatably received in the barrel 102 of the tubular body 1, and includes a projection 301 extended therefrom and engaged into the recess 201 of the ball valve member 2, in order to rotate the ball valve member 2 relative to the tubular body 1 when the shank 3 is rotated relative to the barrel 102 of the tubular body 1. A lock nut 8 is threaded with an inner thread 105 of the barrel 102, in order to rotatably secure the shank 3 in the barrel 102 of the tubular body 1.

One or more gaskets or sealing rings 7 may further be provided and engaged between the shank 3 and the barrel 102 of the tubular body 1, in order to make a water tight seal between the shank 3 and the barrel 102 of the tubular body 1. A handle 4 is secured to the shank 3 with another lock nut 9, in order to rotate the shank 3 relative to the barrel 102 of the tubular body 1, so as to selectively open or block the lateral passage 101 of the tubular body 1.

The typical ball valve as shown in FIG. 1 includes a tubular body 1 having a one-integral-piece configuration that the ball valve member 2 may not be easily engaged into the lateral passage 101 of the tubular body 1. In addition, a lock nut 6 is required to be threaded with the inner thread 103 that is also required to be formed in the tubular body 1, such that the assembling of the ball valve member 2 into the tubular body 1 is complicated. Furthermore, it will be difficult for the workers or the users to engage or assemble the lock nut 6 into the tubular body 1.

The present invention has arisen to mitigate and/or obviate the afore-described disadvantages of the conventional ball valves.

### SUMMARY OF THE INVENTION

The primary objective of the present invention is to provide a ball valve including a structure for allowing the ball valve to be easily manufactured and assembled.

In accordance with one aspect of the invention, there is provided a ball valve comprising a tubular body including a lateral passage formed therein, and including a middle portion having an annular flange extended radially into the passage thereof, and including a first end having an inner thread formed therein, and a second end having a valve chamber formed therein and having a cylindrical wall formed therein, the tubular body including a barrel extended from the second end thereof, a first gasket engaged into the valve chamber of the tubular body, and contacted with the annular flange of the tubular body, a ball valve member rotatably received in the valve chamber of the tubular body, and including a bore formed therein to selectively align with the lateral passage of the tubular body, in order to control water flowing through the tubular body, the ball valve member including a first side engaged with the first gasket, and including a second side, a shank rotatably received in the barrel of the tubular body and coupled to the ball valve member, to rotate the ball valve member relative to the tubular body when the shank is rotated relative to the barrel of the tubular body, a handle secured to the shank to rotate the shank and thus to rotate the ball valve member relative to the tubular body, a second gasket engaged into the valve chamber of the tubular body, and engaged with the second side of the bal valve member, a duct including a bore formed therein to selectively communicate with the lateral passage of the tubular body and the bore of the ball valve member, and including a first end having a peripheral swelling extended therefrom and engaged into the valve chamber of the tubular body, and having a peripheral shoulder formed therein to receive the cylindrical wall of the second end of the tubular body, and a welding member provided and engaged around the cylindrical wall of the tubular body and the duct, to solidly secure the duct to the tubular body. The first and the second gaskets and the ball valve member may be easily engaged or assembled into the valve chamber of the tubular body before the peripheral swelling of the duct is engaged into the valve chamber of the tubular body, and before the duct is welded or secured to the tubular body.

The peripheral swelling of the duct includes an outer diameter smaller than that of the duct to form and define a peripheral shoulder on an outer peripheral portion thereof, and to receive the cylindrical wall of the tubular body.

The second gasket includes a peripheral groove formed therein and facing toward the duct, the duct includes a peripheral rib extended therefrom and engaged into the peripheral groove of the second gasket, to solidly engage with the second gasket, and to position the second gasket to the duct and the tubular body.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view illustrating one of the typical ball valves;

FIG. 2 is a cross sectional view illustrating a ball valve in accordance with the present invention;

FIG. 3 is an enlarged partial cross sectional view of the ball valve;

FIG. 4 is a cross sectional view similar to FIG. 2, illustrating another arrangement of the ball valve; and

FIG. 5 is an enlarged partial cross sectional view of the ball valve as shown in FIG. 4.

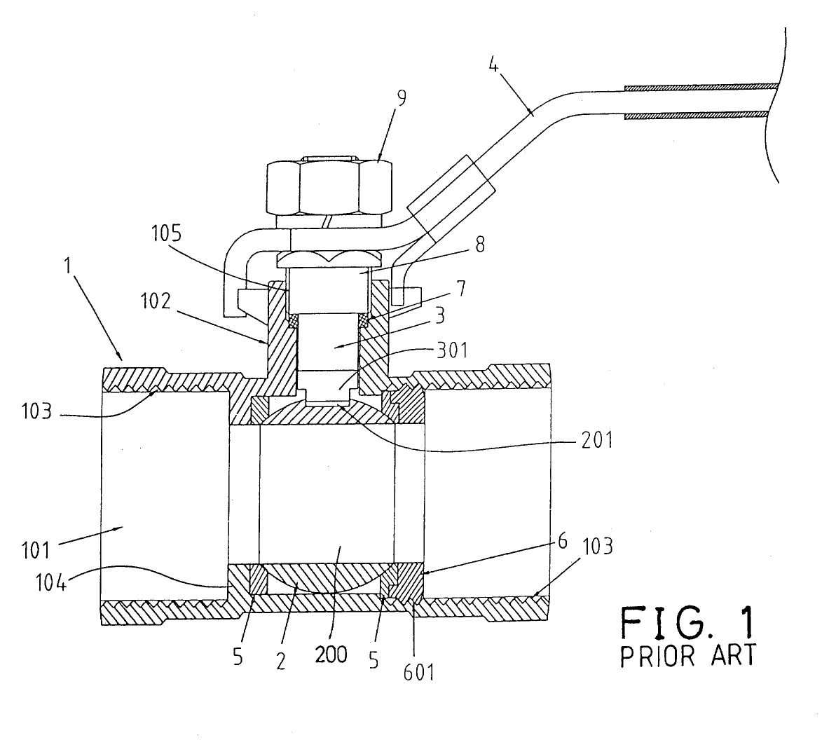

### DETAILED DESCRIPTION OF THE PREFERRED EMBODIMENT

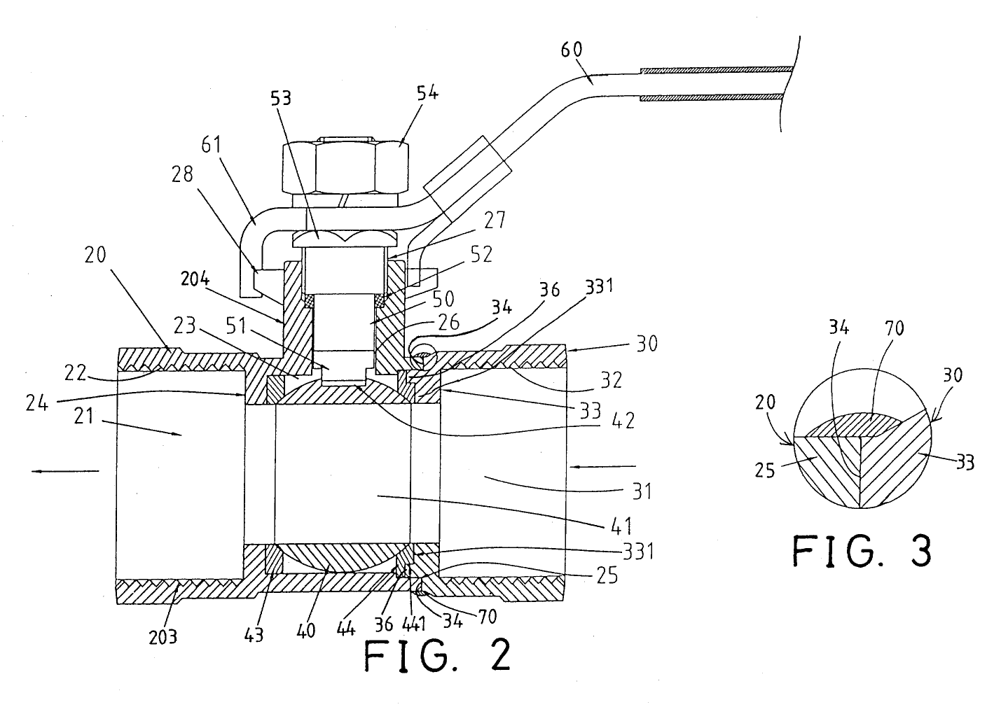

Referring to the drawings, and initially to FIGS. 2 and 3, a ball valve 20 in accordance with the present invention comprises a cylindrical or tubular body 20 including a lateral passage 21 formed therein, and including an annular flange 24 extended radially into the passage 21 of the tubular body 20, and including an inner thread 22 formed in one end thereof to thread and to couple or secure to the other hoses or pipes (not shown), and a valve chamber 23 formed in the other end thereof.

A ball valve member 40 is rotatably received in the valve chamber 23 of the tubular body 20, and a washer or Teflon gasket 43 is engaged between the annular flange 24 of the tubular body 20 and one side of the ball valve member 40, in order to make a water tight seal between the tubular body 20 and the ball valve member 40. The ball valve member 40 includes a bore 41 formed therein to selectively align with the lateral passage 21 of the tubular body 20, in order to control the water flowing through the tubular body 20.

The ball valve member 40 further includes a recess 42 formed in the upper portion thereof.

The tubular body 20 includes a barrel 204 extended upwardly from the other end portion thereof, and having a bore 26 formed therein and communicating with the valve chamber 23 of the tubular body 20. A shank 50 is rotatably received in the barrel 204 of the tubular body 20, and includes a projection 51 extended therefrom and engaged into the recess 42 of the ball valve member 40, in order to rotate the ball valve member 40 relative to the tubular body 20 when the shank 50 is rotated relative to the barrel 204 of the tubular body 20. A lock nut 53 is threaded with an inner thread 27 of the barrel 204, in order to rotatably secure the shank 50 in the barrel 204 of the tubular body 20.

One or more gaskets or sealing rings 52 may further be provided and engaged between the shank 50 and the barrel 204 of the tubular body 20, in order to make a water tight seal between the shank 50 and the barrel 204 of the tubular body 20. A handle 60 is secured to the shank 50 with another lock nut 54, in order to rotate the shank 50 relative to the barrel 204 of the tubular body 20, so as to selectively open or block the lateral passage 21 of the tubular body 20. The handle 60 may further include one end 61 for engaging with one or more extensions 28 of the shank 50, so as to limit the rotational movement of the shank 50 relative to the barrel 204 of the tubular body 20.

Another washer or Teflon gasket 44 is further provided and engaged with the other side of the ball valve member 40, and engaged with the tubular body 20, in order to make a water tight seal between the tubular body 20 and the other side of the ball valve member 40. The above described structure is conventional and will not be described in further details.

The ball valve 20 in accordance with the present invention further comprises a duct 30 including a bore 31 formed therein to selectively communicate with the lateral passage 21 of the tubular body 20 and the bore 41 of the ball valve member 40, and including an inner thread 32 formed therein to thread or couple to the other hoses or pipes (not shown). The duct 30 includes one end 33 having a peripheral swelling 331 extended therefrom for engaging into the valve chamber 23 of the tubular body 20.

The peripheral swelling 331 of the duct 30 includes an outer diameter smaller than that of the duct 30, to form or define a peripheral shoulder 34 on the outer peripheral portion thereof, and to receive the cylindrical wall 25 of the other end of the tubular body 20. The duct 30 may thus be easily and quickly positioned and secured onto the other end of the tubular body 20, by the engagement of the peripheral swelling 331 of the duct 30 into the valve chamber 23 of the tubular body 20.

A welding member 70 may further be provided and engaged around the adjacent portions or contacting portions of the cylindrical wall 25 of the other end of the tubular body 20 and the duct 30, in order to solidly secure the duct 30 to the tubular body 20. It is to be noted that the ball valve member 40 and the gaskets 43, 44 may be easily and quickly engaged into or assembled into the valve chamber 23 of the tubular body 20, and the peripheral swelling 331 of the duct 30 may be easily and quickly engaged into the valve chamber 23 of the tubular body 20 to retain the gaskets 43, 44 and the ball valve member 40 within the valve chamber 23 of the tubular body 20, and the duct 30 may be solidly secured to the tubular body 20 with the welding member 70, such that the ball valve 20 may be easily manufactured and assembled.

The gasket 44 may include a peripheral groove 441 formed therein, such as formed in the outer side thereof that faces toward the duct 30. The duct 30 may include a peripheral or cylindrical rib 36 further extended therefrom and engaged into the peripheral groove 441 of the gasket 44, for solidly engaging with and positioning the gasket 44 to the duct 30. The duct 30 or the peripheral swelling 331 of the duct 30 may engage with the gasket 33, to force the gasket 44 to solidly engage with the ball valve member 40, and to make a water tight seal between the ball valve member 40 and the duct 30.

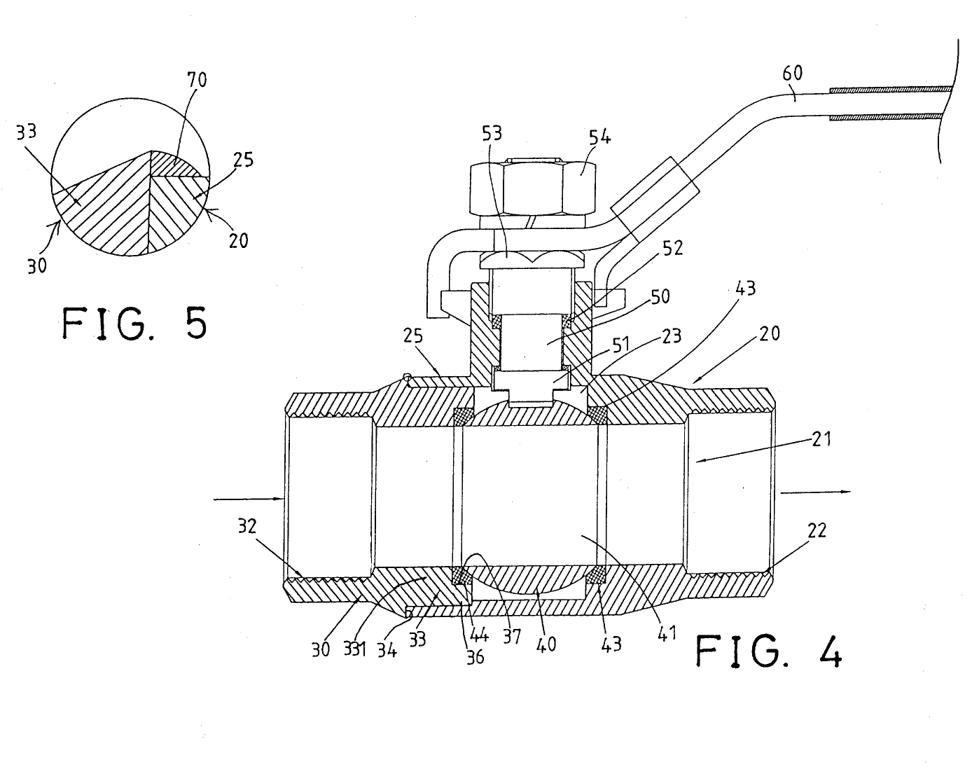

As shown in FIGS. 4 and 5, the ball valve 20 may include a duct 30 having a peripheral or cylindrical rib 36 extended therefrom, and having a peripheral depression 37 formed between the duct 30 and the peripheral or cylindrical rib 36, in order to receive the gasket 44, and for allowing the gasket 44 to be solidly engaged into and positioned in the peripheral depression 37 of the duct 30, such that the gasket 44 may further be solidly retained between the ball valve member 40 and the duct 30.

It is also to be noted that the ball valve member 40 and the gaskets 43, 44 may also be easily and quickly engaged into or assembled into the valve chamber 23 of the tubular body 20, and the peripheral swelling 331 of the duct 30 may also be easily and quickly engaged into the valve chamber 23 of the tubular body 20, in order to engage with and to force the gasket 44 to engage with the ball valve member 40. In addition, the duct 30 may be solidly secured to the tubular body 20 with the welding member 70, such that the ball valve 20 may also be easily manufactured and assembled.

The engagement of the peripheral swelling 331 of the duct 30 into the valve chamber 23 of the tubular body 20 and/or the engagement of the cylindrical wall 25 of the other end of the tubular body 20 in the peripheral shoulder 34 of the duct 30 allows the duct 30 to be easily and quickly secured and positioned to the tubular body 20. The duct 30 and the tubular body 20 may further be solidly secured together with the welding member 70.

The peripheral swelling 331 of the duct 30 is not required to be threaded to the tubular body 20, and the cylindrical wall 25 of the tubular body 20 is also not required to be threaded to the duct 30, such that no threads are required to be formed in the peripheral swelling 331 of the duct 30 and the cylindrical wall 25 of the tubular body 20, and such that the thicknesses of the peripheral swelling 331 of the duct 30 and the cylindrical wall 25 of the tubular body 20 may be increased or maintained, and such that the strength of both the peripheral swelling 331 of the duct 30 and the cylindrical wall 25 of the tubular body 20 may be maintained or increased.

Accordingly, the ball valve in accordance with the present invention includes a configuration or a structure for allowing the ball valve to be easily manufactured and assembled.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ball valve comprising:
a tubular body including a lateral passage formed therein, and including a middle portion having an annular flange extended radially into said passage thereof, and including a first end having an inner thread formed therein, and a second end having a valve chamber formed therein and having a cylindrical wall formed therein, said tubular body including a barrel extended from said second end thereof,
a first gasket engaged into said valve chamber of said tubular body, and contacted with said annular flange of said tubular body,
a ball valve member rotatably received in said valve chamber of said tubular body, and including a bore formed therein to selectively align with said lateral passage of said tubular body, in order to control water flowing through said tubular body, said ball valve member including a first side engaged with said first gasket, and including a second side,
a shank rotatably received in said barrel of said tubular body and coupled to said ball valve member, to rotate said ball valve member relative to said tubular body when said shank is rotated relative to said barrel of said tubular body,
a handle secured to said shank to rotate said shank and thus to rotate said ball valve member relative to said tubular body,
a second gasket engaged into said valve chamber of said tubular body, and engaged with said second side of said bal valve member,
a duct including a bore formed therein to selectively communicate with said lateral passage of said tubular body and said bore of said ball valve member, and including a first end having a peripheral swelling extended therefrom and engaged into said valve chamber of said tubular body, and having a peripheral shoulder formed therein to receive said cylindrical wall of said second end of said tubular body, and
a welding member provided and engaged around said cylindrical wall of said tubular body and said duct, to solidly secure said duct to said tubular body.

2. The ball valve as claimed in claim 1, wherein said peripheral swelling of said duct includes an outer diameter smaller than that of said duct to form and define a peripheral shoulder on an outer peripheral portion thereof, and to receive said cylindrical wall of said tubular body.

3. The ball valve as claimed in claim 1, wherein said second gasket includes a peripheral groove formed therein and facing toward said duct, said duct includes a peripheral rib extended therefrom and engaged into said peripheral groove of said second gasket, to solidly engage with said second gasket, and to position said second gasket to said duct and said tubular body.
